(19) United States
(12) Patent Application Publication
(10) Pub. No.: US 2014/0366131 A1
(43) Pub. Date: Dec. 11, 2014

(54) SECURE BUS SYSTEM

(71) Applicant: Andes Technology Corporation, Hsin-Chu City (TW)

(72) Inventor: Chi-Chang Lai, Hsinchu County (TW)

(21) Appl. No.: 13/912,206

(22) Filed: Jun. 7, 2013

(51) Int. Cl. G06F 21/85

(52) U.S. Cl. CPC G06F 21/85
USPC 726/21

(57) ABSTRACT

The invention discloses a secure bus system and a bus system security method. The secure bus system includes a bus interconnect structure, a bus master, a bus device and a security control module. The security control module determines a device security attribute for the bus device. When the master security attribute of the bus master or the device security attribute of the bus device has changed, the security control module determines a security permission flag related to the bus master. When the security control module receives a bus transaction from the bus master, the security control module determines whether a security violation condition happens between the bus master and the bus device according to the security permission flag. If the security violation condition happens, the security control module triggers a security violation handling process to further restrict accessibility of the bus master to the bus device.

### BACKGROUND

1. Field of the Invention

The invention relates to a secure system, in particular, to a secure bus system.

2. Description of Related Art

In a regular bus system, there usually exists a security mechanism for determining whether a bus master is qualified to access (e.g., sending bus transactions) a bus device. In general, when the bus device receives a bus transaction from the bus master, the bus device checks whether the bus master is secure enough to access the bus device by comparing its security attribute or security level with the security attribute or security level of the bus transaction. In other words, the bus device has to perform such checking procedure (i.e., comparing the security attributes of the bus device and the bus master) upon every received bus transaction, which is inefficient and power-consuming.

### SUMMARY

Accordingly, the present invention is directed to a secure bus system, which provides a novel, effective and power-efficient way to determine whether a bus master is allowed to access the bus device.

A secure bus system is introduced herein. The secure bus system includes a bus interconnect structure, a bus master, a bus device and a security control module. The bus master is coupled to the bus interconnect structure, having a master security attribute. The security control module is coupled between the bus device and the bus interconnect structure, determining a device security attribute for the bus device. When the master security attribute of the bus master has changed, or the device security attribute of the bus device has changed, the security control module determines a security permission flag related to the bus master. The security permission flag is configured for indicating whether the bus master is secure enough to access the bus device. When the security control module receives a bus transaction from the bus master, the security control module determines whether a security violation condition happens between the bus master and the bus device according to the security permission flag related to the bus master. If the security violation condition happens, the security control module triggers a security violation handling process to further restrict accessibility of the bus master to the bus device.

In an embodiment of the present invention, the security control module is configured for determining whether the security control module is in an initialization stage. If the security control module is in the initialization stage, the security control module sets the device security attribute according to a default security attribute of the security control module. If the security control module is not in the initialization stage, the security control module determines whether the bus device is bundled with another device. If the bus device is bundled with the other device, the security control module sets the device security attribute according to a security attribute of the other device. If the bus device is not bundled with the other device, the security control module sets the device security attribute according to a reception condition of a security control transaction from the bus master.

In an embodiment of the present invention, after the security control module determines the security control module is in the initialization stage, the security control module is configured for determining whether the default security attribute of the security control module is valid. If the default security attribute of the security control module is valid, the security control module sets the device security attribute as the default security attribute and sets a default state of the security control module as a known state. If the default security attribute of the security control module is not valid, the security control module sets the default state of the security control module as an open state.

In an embodiment of the present invention, the secure bus system further includes a security decision unit, coupled to the bus interconnect structure. After the default state of the security control module is set, the security control module is configured for determining whether a default state setting information is received from the security decision unit. If the default state setting information is received from the security decision unit, the security control module modifies the default state of the security control module according to the default state setting information from the security decision unit. If the default state setting information is not received from the security decision unit, the security control module maintains the default state of the security control module.

In an embodiment of the present invention, after the security control module determines the bus device is bundled with another device, the security control module is configured for setting the device security attribute according to a security attribute of the other device when the other device has the security attribute.

In an embodiment of the present invention, after the security control module determines the bus device is not bundled with another device, the security control module is configured for setting the device security attribute of the bus device as the master security attribute of the bus master when receiving the security control transaction from the bus master.

In an embodiment of the present invention, the security control module determines the security permission flag related to the bus master by comparing the device security attribute of the bus device and the master security attribute of the bus master. When the device security attribute is defined to be less secure than the master security attribute, the security control module sets the security permission flag related to the bus master to be a first flag state, wherein the first flag state of the security permission flag represents that the bus master is secure enough to access the bus device. When the device security attribute is defined to be more secure than the master security attribute, the security control module sets the security permission flag related to the bus master to be a second flag state, wherein the second flag state of the security permission flag represents that the bus master is not secure enough to access the bus device.

In an embodiment of the present invention, when the security control module receives the bus transaction from the bus master, the security control module is configured for determining whether the security control module is in a trap state, wherein the trap state represents that the bus master cannot normally access the bus device. If the security control module is not in a trap state, the security control module determines whether the security permission flag related to the bus master is the first flag state. If the security permission flag related to the bus master is not the first flag state, the security control module defines that the security violation condition has happened.

In an embodiment of the present invention, when the security control module triggers the security violation handling process, the security control module is configured for transiting into the trap state and determining a blocked area in the bus device.

In an embodiment of the present invention, when the security control module triggers the security violation handling process, the security control module is configured for responding the bus master with a normal response without correctly executing corresponding functions requested in the bus transaction.

In an embodiment of the present invention, when the security control module triggers the security violation handling process, the security control module is configured for responding a dummy data when the bus transaction is a read request.

In an embodiment of the present invention, the secure bus system further includes a security decision unit, coupled to the bus interconnect structure. When the security control module triggers the security violation handling process, the security control module is configured for sending a notification to the security decision unit about the security violation condition. After receiving the notification, the security decision unit restrict the master security attribute of the bus master related to the security violation condition. The security decision unit sends a security resynchronization signal to the security control module to adjust the security permission flag related to the bus master.

In an embodiment of the present invention, the secure bus system further includes a security decision unit, coupled to the bus interconnect structure. When the security control module triggers the security violation handling process, the security control module is configured for sending a notification to the security decision unit about the security violation condition. After receiving the notification, the security decision unit disables the bus master that causes the security violation condition.

In an embodiment of the present invention, the secure bus system further includes a primary bus master, coupled to the bus interconnect structure. When the security control module triggers the security violation handling process, the security control module is configured for sending a notification to the primary bus master about the security violation condition After receiving the notification, the primary bus master handles the security violation condition for the bus master that causes the security violation condition.

In an embodiment of the present invention, when the security control module triggers the security violation handling process, the security control module is configured for sending a notification to the bus master causing the security violation condition. After receiving the notification, the bus master causing the security violation condition may activate a security exception handler for handling the security violation condition.

In an embodiment of the present invention, the secure bus system further includes a power control unit, coupled to the bus interconnect structure through a specific security control module, wherein the power control unit is configured for adjusting an operating condition of the bus device in response to a adjusting request of the bus master. After receiving the adjusting request, the power control unit records the master security attribute of the bus master. The power control unit notifies the security control module of the bus device with the master security attribute of the bus master before adjusting the operating condition of the bus device.

In an embodiment of the present invention, after being notified by the power control unit with the master security attribute of the bus master, the security control module is configured for determining whether the device security attribute of the bus device is defined to be more secure than the master security attribute of the bus master. If the device security attribute of the bus device is not defined to be more secure than the master security attribute of the bus master, the security control module notifies the power control unit to normally adjust the operating condition of the bus device. If the device security attribute of the bus device is defined to be more secure than the master security attribute of the bus master, the security control module determines the security violation condition has happened between the bus master and the bus device.

In an embodiment of the present invention, the security control module further notifies the specific security control module that the security violation condition has happened between the bus master and the bus device. After being notified by the security control module, the specific security control module sets the security permission flag related to the bus master as a second flag state to consider further accessing to the power control unit from the bus master not secure.

A bus system security method is introduced herein. The method is adapted to a secure bus system comprising a bus interconnect structure, a bus master, a bus device and a security control module. The method includes the following steps: determining a device security attribute for the bus device; when a master security attribute of the bus master has changed, or the device security attribute of the bus device has changed, determining a security permission flag related to the bus master, wherein the security permission flag is configured for indicating whether the bus master is secure enough to access the bus device; when receiving a bus transaction from the bus master, determining whether a security violation condition happens between the bus master and the bus device according to the security permission flag related to the bus master; if the security violation condition happens, triggering a security violation handling process to further restrict accessibility of the bus master to the bus device.

Based on the above description, the embodiments of the present invention provide a novel, effective and power-efficient way for the security control module to determine whether the bus master is allowed to access the bus device related to the security control module by comparing the master security attribute of the bus master and the device security attribute of the bus device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a secure bus system according to an exemplary embodiment of the present invention.

FIG. 2 is a flow chart illustrating a bus system security method for the secure bus system according to an exemplary embodiment of the present invention.

FIG. 3 is a flow chart illustrating the method for the security control module to determine the device security attribute for the bus device according to FIG. 2.

FIG. 4A is a schematic diagram illustrating a secure bus system according to an exemplary embodiment of the present invention.

FIG. 4B is a schematic diagram illustrating a secure bus system according to FIG. 4A.

FIG. 4C is a schematic diagram illustrating a secure bus system according to FIG. 4A.

FIG. 5A is a schematic diagram illustrating a secure bus system according to FIG. 4C.

FIG. 5B is a schematic diagram illustrating a secure bus system according to FIG. 4C.

FIG. 5C is a schematic diagram illustrating a secure bus system according to FIG. 4C.

FIG. 5D is a schematic diagram illustrating a secure bus system according to FIG. 5A-5C.

### DETAILED DESCRIPTION OF DISCLOSED EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

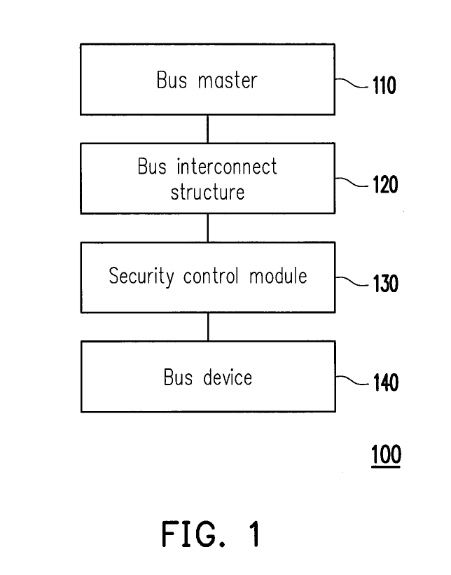

FIG. 1 is a schematic diagram illustrating a secure bus system according to an exemplary embodiment of the present invention. In the present embodiment, the secure bus system 100 includes a bus master 110, a bus interconnect structure 120, a security control module 130 and a bus device 140. The bus master 110 is coupled to the bus interconnect structure 120, and may be a regular bus master, which has the ability to perform bus transaction interactions with other devices through the bus interconnect structure 120. The bus interconnect structure 120 may be a bus structure configured for interconnecting the elements within the secure bus system 100. In some embodiments, the bus interconnect structure 120 may be implemented by a series of hierarchically connected bus structures, but the invention is not limited thereto. Herein, the bus master 110 may determine a master security attribute for itself, and hence the bus master 100 can be referred as a secure bus master. In some embodiments, the bus master 110 may determine its master security attribute by executing a security management software through a built-in micro-processor. The micro-processor may determine the master security attribute according to the runtime environment of the security management software to fullfill various needs of the security management software. The master security attribute can be regarded as a determination reference about whether the bus master 110 is allowed to access other bus devices (such as the bus device 140) through the bus interconnect structure 120. In other embodiments, when a specific bus master is not able to determine a master security attribute for itself (which may be referred as a non-secure bus master), a master security control module could be incorporated and coupled between the specific bus master and the bus interconnect structure related to the specific bus structure to determine the master security attribute for the specific bus master (i.e., the non-secure bus master). The master security control module may be interpreted as a module with the ability to handle security functions for the non-secure bus master. From another point of view, the combination of the non-secure bus master and the master security control module may be regarded as one kind of the secure bus master.

The bus device 140 may be a regular bus device that can perform the bus transactions interaction with the bus master 110 through the bus interconnect structure 120. The security control module 130 is coupled between the bus device 140 and the bus interconnect structure 120. The security control module 130 may be interpreted as a module with the ability to handle security functions for the bus device 140. Although the security control module 130 is illustrated outside of the bus interconnect structure 120 in FIG. 1, in other embodiments, the security control module 130 may be integrated into the bus interconnect structure 120, such that the bus interconnect structure 120 may be applied to the secure bus system 100 in a more convenient way. Alternatively, the security control module 130 may also be integrated with the bus device 140 as well.

People with ordinary skills in the art should understand that there should be a security mechanism for determining whether a bus master is qualified to access (e.g., sending bus transactions) a bus device in a regular secure bus system. When an unqualified bus master tries to access a bus device, the security mechanism may timely operate to protect the bus device from the access of the unqualified bus master. Roughly speaking, the security mechanism in the present invention is implemented based on the comparison between the master security attribute of the bus master 110 and the device security attribute of the bus device 140. The detailed discussion would be provided in the following descriptions.

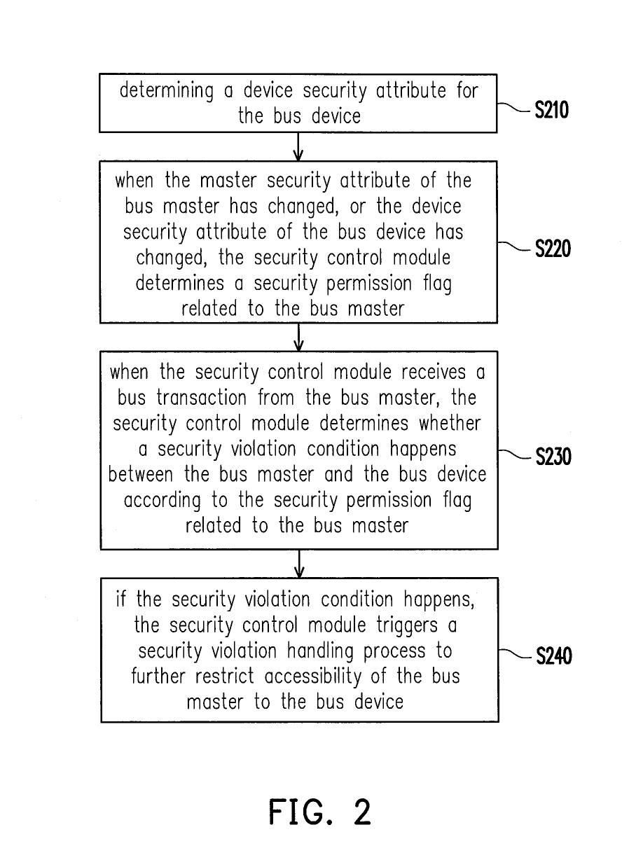

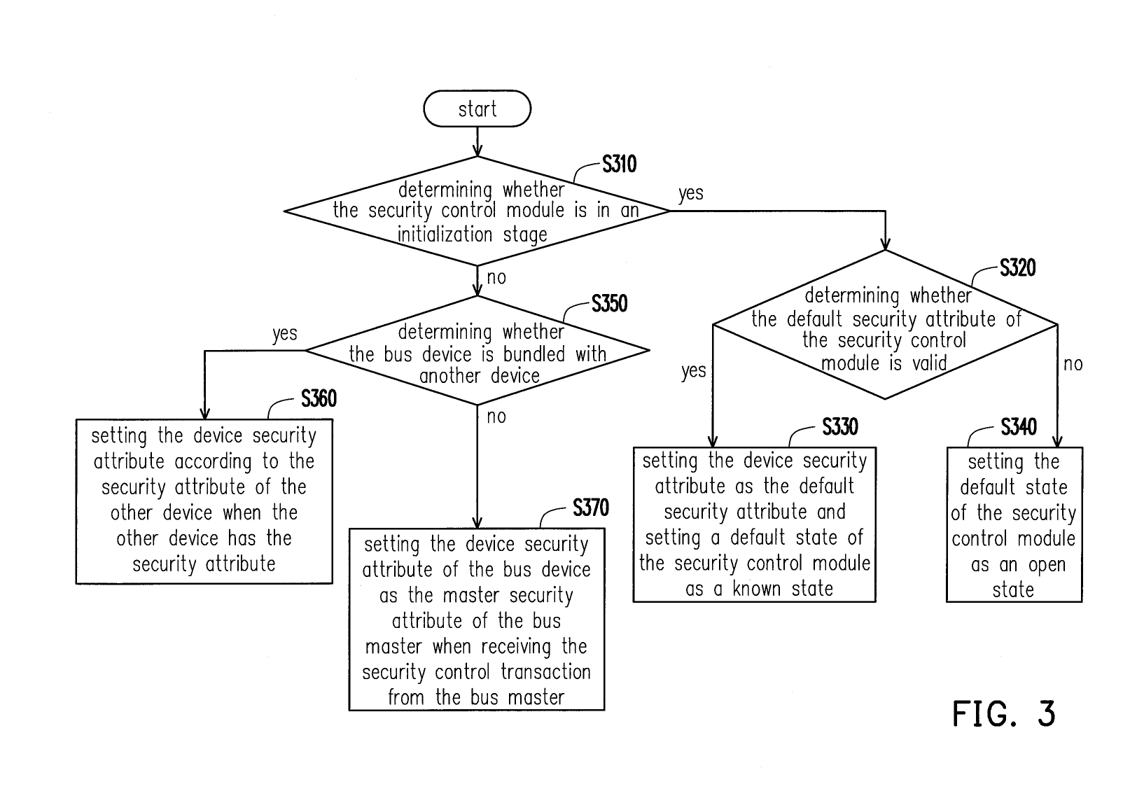

FIG. 2 is a flow chart illustrating a bus system security method for the secure bus system according to an exemplary embodiment of the present invention. Referring to both FIG. 1 and FIG. 2, the proposed bus system security method may be adapted for the secure bus system 100, but the invention is not limited thereto. In step S210, the security control module 130 may determine the device security attribute for the bus device. Generally speaking, the security control module 130 may firstly determine whether it is in an initialization stage. The initialization stage could be generalized to any kind of initializing process for the bus device 140, such as the hardware initialization or the software initialization occurring on the security control module 130, the bus device 140 or the secure bus system 100, but the invention is not limited thereto. If the security control module 130 is in the initialization stage, the security control module 130 may set the device security attribute according to a default security attribute of the security control module 130. If the security control module 130 is not in the initialization stage, the security control module 130 may determine whether the bus device 140 is bundled with another device. If the bus device 140 is bundled with another device, the security control module 130 may set the device security attribute of the bus device 140 according to a security attribute of the other device. If the bus device 140 is not bundled with another device, the security control module 130 may set the device security attribute according to a reception condition of a security control transaction from the bus master 110. The detailed discussion of the operation in step S210 would be provided in the following embodiment of FIG. 3.

Afterwards, in step S220, when the master security attribute of the bus master 110 has changed, or the device security attribute of the bus device 140 has changed, the security control module 130 may determine a security permission flag related to the bus master 110. Specifically, the security control module 130 determines the security permission flag related to the bus master 110 by comparing the device security attribute of the bus device 140 and the master security attribute of the bus master 110. When the device security attribute is defined to be less secure than the master security attribute, the security control module 130 sets the security permission flag related to the bus master 110 to be a first flag state. The first flag state of the security permission flag represents that the bus master 110 is secure enough to access the bus device. On the other hand, when the device security attribute is defined to be more secure than the master security attribute, the security control module 130 sets the security permission flag related to the bus master 110 to be a second flag state. The second flag state of the security permission flag represents that the bus master 110 is not secure enough to access the bus device 140.

From another point of view, the master security attribute and the device security attribute could be regarded as parameters that respectively representing the security levels of the bus master 110 and the bus device 140. Herein, when the security level characterized by the master security attribute is higher than the security level characterized by the device security attribute, the bus master 110 is defined to be more secure than the bus device 140, and hence the bus master 110 is secure enough to access the bus device 140. On the contrary, when the security level characterized by the master security attribute is lower than the security level characterized by the device security attribute, the bus master 110 is defined to be less secure than the bus device 140, and hence the bus master 110 is not secure enough to access the bus device 140. Besides, when the bus master 110 and the bus device 140 are equally secure (e.g., the master security attribute is equal to the device security attribute), the determination about whether the bus master 110 is secure enough to access the bus device 140 could be defined by the designer. For example, the designer may define that the bus master 110 is secure enough to access the bus device 140 when the master security attribute is equal to the device security attribute. Or, the designer may instead define that the bus master 110 is not secure enough to access the bus device 140 when the master security attribute is equal to the device security attribute.

Once the security permission flag related to the bus master 110 is determined by comparing the master security attribute and the device security attribute, in step S230 when the security control module 130 receives a bus transaction from the bus master 110, the security control module 130 may determine whether a security violation condition happens between the bus master 110 and the bus device 140 according to the security permission flag related to the bus master 110. In detail, the security control module 130 may determine whether the security control module 130 is in a trap state. When the security control module 130 is in the trap state, this represents that the bus master 110 cannot normally access the bus device 140. When the security control module 130 is not in the trap state, the security control module 130 may determine whether the security permission flag related to the bus master 110 is the first flag state. When the security permission flag related to the bus master 110 is not the first flag state, the security control module 130 may define that the security violation condition has happened.

From another point of view, after determining the security permission flag related to the bus master 110, the security control module 130 may determine whether the bus master 110 is secure enough to access the bus device 140. If the security permission flag related to the bus master 110 is the first flag state, the security control module 130 may directly permit the bus master 110 to access or performing other bus transaction interactions with the bus device 140. That is, the security control module 130 may simply “raise” the security violation according to the state of the security permission flag, instead of repeatedly determining and checking the security attribute according to some security policy upon every bus transaction.

Afterwards, in step S240, when the security violation condition happens, the security control module 130 may trigger a security violation handling process to further restrict accessibility of the bus master 110 to the bus device 140. For example, in the security violation handling process, the security control module 130 may transit into the trap state and determine a blocked area in the bus device 140. The blocked area may be a restricted access area within the bus device 140. The blocked area could be a part of (or all of) the bus address space the bus device 140 is mapped to, which is not limited thereto. In some embodiments, whenever the security control module 130 detects that the bus transaction from the bus master 110 is trying to access the blocked area, the security control module 130 may further adopt other strategy to aggressively protect the data within the bus device 140.

For example, the security control module 130 may send a notification to a device with the authority to disable the bus master 110, such that the bus master 110 cannot send other bus transactions to the bus device 140, but the invention is not limited thereto. From another point of view, the security control module 130 may protect the bus device 140 in a more aggressive way by preventing the “possible malicious” programs running on the bus master 110 to access some un-permitted resource of the bus device 140 through some security hole of the secure bus system 100. In other embodiments, after the blocked area of the bus device 140 is determined, the security control module 130 may further protect the blocked area from being accessed by other bus masters, instead of only protecting the blocked area from the bus master 110. Under this situation, all of the bus master 110 and the other bus masters cannot send bus transactions to the bus device 140.

In an embodiment, when the security control module 130 triggers the security violation handling process, the security control module 130 may respond the bus master 110 with a normal response without correctly executing corresponding functions requested in the bus transaction. For example, if the bus transaction is a write request, the security control module 130 may respond the bus master 110 with the normal response to inform the bus master 110 that the bus transaction has been normally processed. However, in fact, the security control module 130 may just ignore the bus transaction since it is from the bus master 110, which is not secure enough to access the bus device 140.

In another embodiment, when the security control module 130 triggers the security violation handling process, the security control module 130 may respond a dummy data when the bus transaction is a read request. That is, after knowing that the bus master 110, which is not secure enough to access the bus device 140, is trying to read data from the bus device 140, the security control module 130 may simply respond the bus master 110 with wrong data, such that the bus master 110 cannot actually obtain the desired data.

As a result, the embodiments of the present invention provide a novel, effective and power-efficient way for the security control module to determine whether the bus master is allowed to access the bus device related to the security control module. In short, after the security attributes of the bus master and the bus device are determined, the security control module may set the permission security flag to be the first flag state (i.e., the bus master is more secure than the bus device) or the second flag state (i.e., the bus master is less secure than the bus device) by comparing the master security attribute of the bus master and the device security attribute of the bus device. If the security permission flag related to the bus master is the first flag state, the security control module may allow the bus device to directly process the received bus transaction from the bus master. On the other hand, if the security permission flag related to the bus master is the second flag state, the security control module may detect that there occurs the security violation condition when there is a bus transaction from the bus master to access the bus device, and accordingly perform other corresponding protective measures to further restrict accessibility of all of the bus masters in the secure bus system. to the bus device. Therefore, the security control module does not need to determine and compare security attributes upon every bus transaction, and hence the power consumption could be significantly reduced.

FIG. 3 is a flow chart illustrating the method for the security control module to determine the device security attribute for the bus device according to FIG. 2. Referring to both FIG. 1 and FIG. 3, the proposed bus system security method may be adapted for the secure bus system 100, but the invention is not limited thereto. In step S310, the security control module 130 may determine whether the security control module 130 is in an initialization stage. If yes, the security control module 130 may perform steps S320-S340 to set the device security attribute according to a default security attribute of the security control module 130. Specifically, in step S320, the security control module 130 may determine whether the default security attribute of the security control module 130 is valid.

In step S330, the security control module 130 may set the device security attribute of the bus device 140 as the default security attribute of the security control module 130. Further, the security control module 130 may set a default state of the security control module 130 as a known state. When the security control module 130 is in the known state, it represents that when the security control module 130 detects the bus transaction from the bus master 110, the security control module 130 may determine whether to process the bus transaction according to the security permission flag related to the bus master 110. However, in other embodiments, the security control module 130 may not be configured with the default security attribute during the manufacturing process. Hence, after step S320, the security control module 130 may proceed to step S340 to set the default state of the bus device 140 as an open state. When the bus device 140 is in the open state, it represents that the bus device 140 would process any received bus transaction with no security checking.

On the other hand, if the security control module 130 determines that the security control module 130 is not in the initialization stage after step S310, the security control module 130 may proceed to step S350. In step S350, the security control module 130 may determine whether the bus device 140 is bundled with another device.

If the bus device 140 is bundled with another device, the security control module 130 may proceed to step S360 to set the device security attribute according to the security attribute of the other device when the other device has the security attribute. That is, when the bus device 140 is defined to be bundled (or grouped) with the other device, the security control module 130 may directly take the security attribute of the other device as the device security attribute of the bus device 140. The other device may be the bus master 110, other bus master (not shown) other than the bus master 110 or other bus device (not shown). When the other device is the bus master 110, the security attribute of the other device may be the master security attribute of the bus master. When the other device is the other bus master other than the bus master 110, the security attribute of the other device may be the master security attribute of the other bus master. When the other device is the other bus device, the security attribute of the other device may be the device security attribute of the other bus device.

On the other hand, if the bus device 140 is not bundled with the other device, the security control module 130 may proceed to step S370 to set the device security attribute of the bus device 140 as the master security attribute of the bus master 110 when receiving a security control transaction from the bus master 110. In detail, the security control transaction is a specific transaction being configured for the bus master 110 to set the device security attribute of the bus device 140. That is, when the security control module 130 detects the security control transaction from the bus master 110 while being in the open state, the security control module 130 may directly set the device security attribute of the bus device 140 to be equal to the master security attribute of the bus master 110. Afterwards, the security control module 130 would transit to the known state. Furthermore, the security control transaction may also be configured for setting the master security attribute for other bus masters (e.g., non-secure bus master or a regular bus master), but the invention is not limited thereto. Furthermore, the security control transaction may be configured for the bus master 100 to transit the security control module 130 from the known state to the open state. However, it should be noted that when the security control module 130 receives the security control transaction while being in the trap state or when the security control transaction has accessed the blocked area, the security control transaction may be considered as resulting in the security violation condition.

Furthermore, even though the security control module 130 has been transited to the known state by the security control transaction, the device security attribute of the bus device 140 could still be modified. However, only the bus master that transited the security control module 130 to the known state has the authority to modify the device security attribute of the bus device 140 again. Specifically, the bus master that transited the security control module 130 to the known state could send another security control transaction to modify the device security attribute of the bus device 140 again.

It should be noted that the procedure of step S370 could be done only when the security control module 130 is in the open state. That is, if the security control module 130 is in the known state or the trap state, the device security attribute of the security control module 130 would not be arbitrarily changed through the security control transaction. Besides, people with ordinary skills in the art should understand that although only one bus master (i.e., the bus master 110) and only one bus device (i.e., the bus device 140) are taken as examples in the previous embodiments, the secure bus system 100 could be generalized to include more bus masters and more paired security control modules and bus devices.

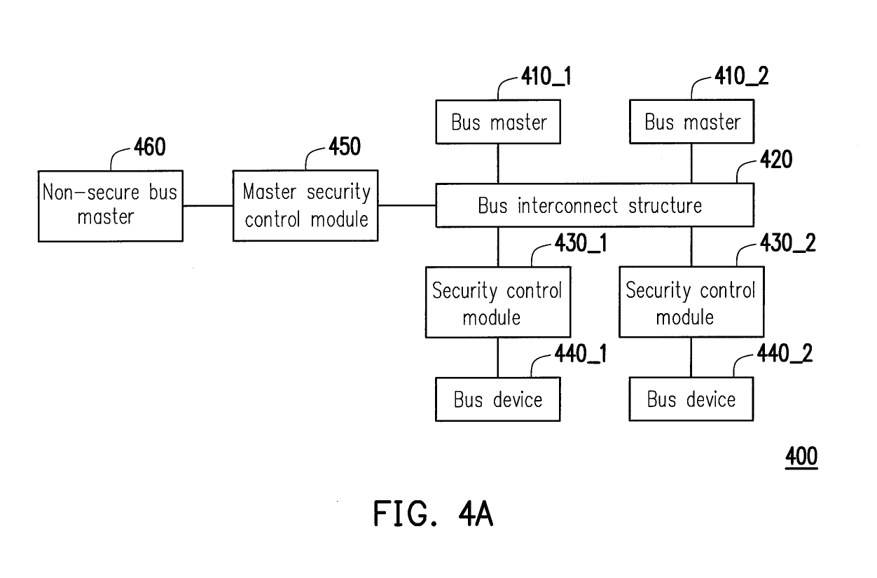

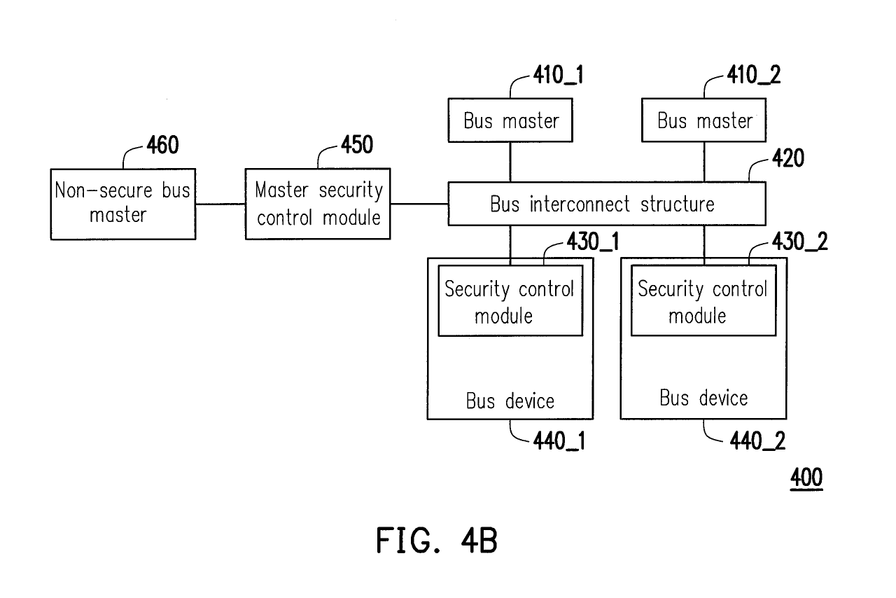

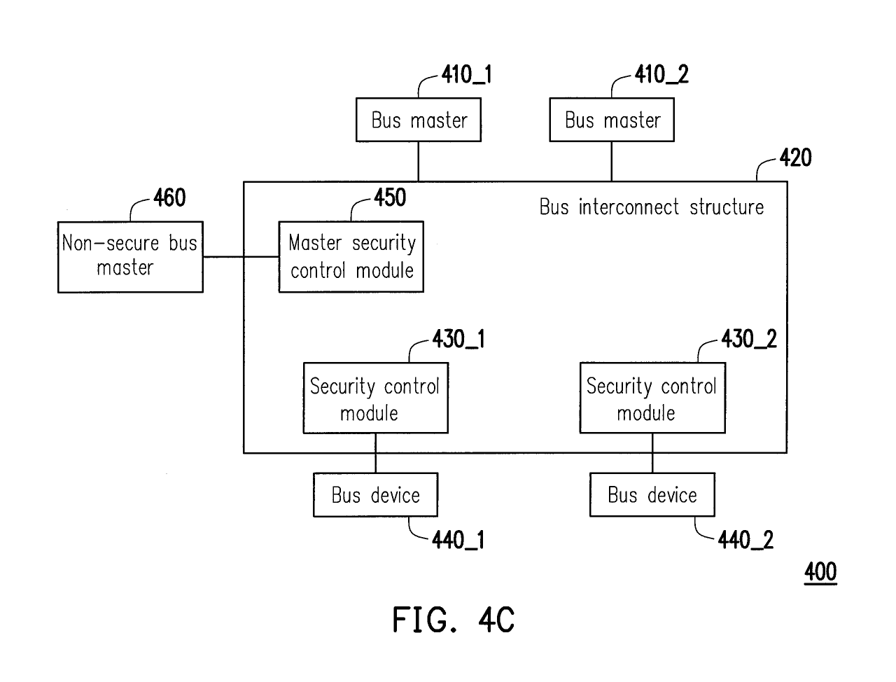

FIG. 4A is a schematic diagram illustrating a secure bus system according to an exemplary embodiment of the present invention. In FIG. 4A, the secure bus system 400 includes bus masters 410_1, 410_2, bus interconnect structure 420, security control module 430_1,430_2, bus devices 440_1,440_2, a master security control module 450 and a non-secure bus master 460. The bus masters 410_1, 410_2 are respectively coupled to the bus interconnect structure 420. The bus device 440_1 is coupled to the bus interconnect structure 420 through the security control module 430_1, and the bus device 440_2 is coupled to the bus interconnect structure 420 through the security control module 430_2. The non-secure bus master 460 is coupled to the bus interconnect structure 420 through the master security control module 450. As mentioned before, the master security control module 450 may handle the security functions for the non-secure bus master 460, similar to the security control module 430_1 and 430_2. The security functions which could be performed by the master security control module 450 includes, for example, performing transition of the security state, determining of the security permission flag, performing security checking for security control transactions and handling security violation, but the invention is not limited thereto. From another point of view, the master security control module 450 could perform the steps of FIG. 2 and FIG. 3 for the non-secure bus master 460, but the invention is not limited thereto.

Referring to both FIG. 2 and FIG. 4A, the security control module 430_1 may perform the steps of FIG. 2 to handle the security function for the bus device 440_1. For example, the security control module 430_1 may perform step S210 to determine the device security attribute for the bus device 440_1 (which may refer to FIG. 3 for detailed description). In step S220, the security control module 430_1 may respectively determine the security permission flag corresponding to each of the bus masters 410_1 and 410_2 by respectively comparing the device security attribute of the bus device 440_1 with the master security attributes of the bus masters 410_1 and 410_2. In step S230, when the security control module 430_1 receives a bus transaction from, for example, the bus master 410_2, the security control module 430_1 may determine whether a security violation condition happens between the bus master 410_2 and the bus device 440_1 according to the security permission flag related to the bus master 410_2. In step S240, if the security violation condition happens, the security control module 430_1 may trigger a security violation handling process to prevent the bus device 440_1 from being accessed by any of the bus masters. Likewise, the security control module 430_2 may be able to perform the aforementioned steps to handle the security function for the bus device 440_2 as well.

FIG. 4B is a schematic diagram illustrating a secure bus system according to FIG. 4A. In the present embodiment, all of the security control modules 4301, 430_2 may be integrated into their corresponding bus devices 440_1, 440_2.

FIG. 4C is a schematic diagram illustrating a secure bus system according to FIG. 4A. In the present embodiment, all of the security control modules 430_1, 4302 may be integrated into the bus interconnect structure 420. Furthermore, the master security control module 450 may also be integrated into the bus interconnect structure 420. Under the situation illustrated in FIG. 4C, the application of the secure bus system 400 may be more flexible and convenient since the security control modules may provide security features for corresponding bus devices having no security features, without changing designs of these devices, and hence saves the engineering effort for implementing the secure bus system 400.

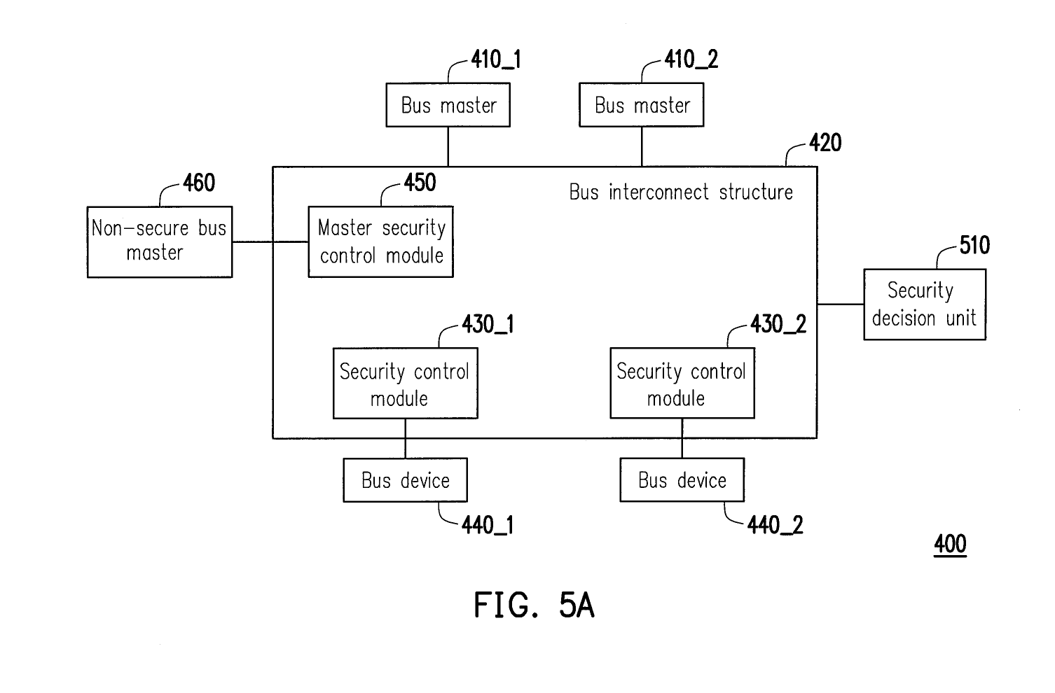

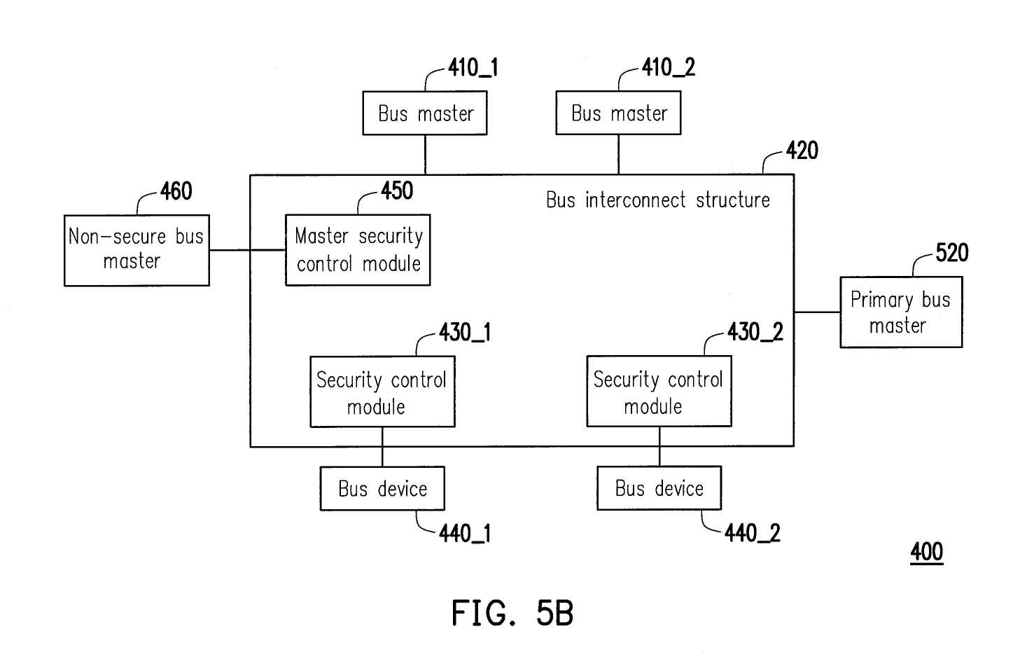

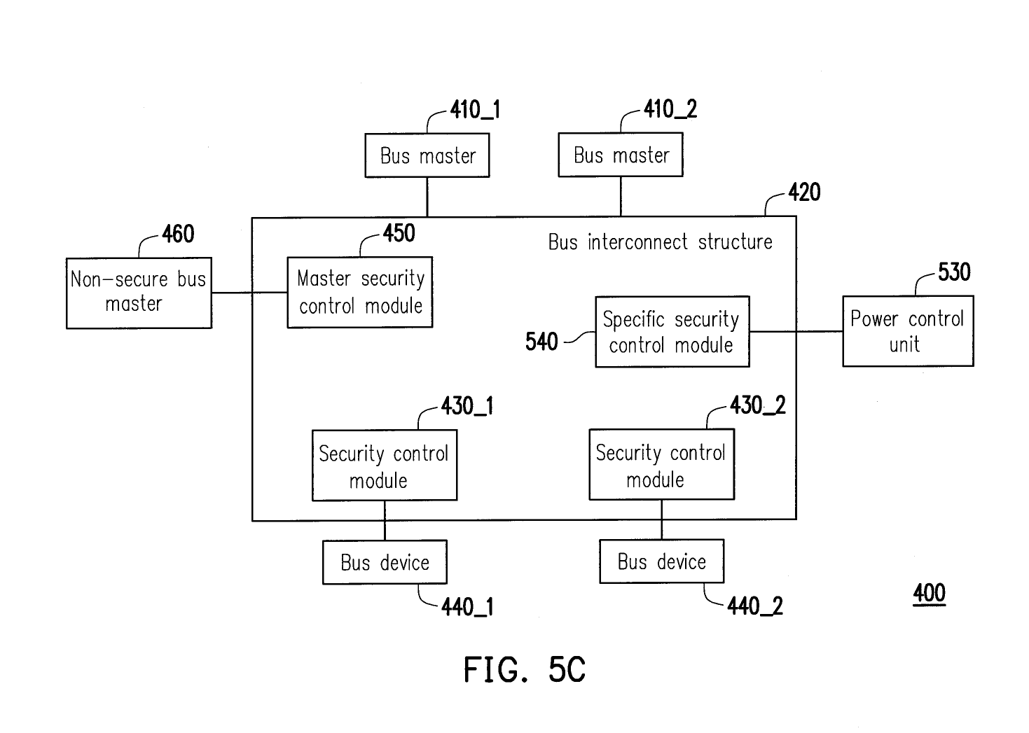

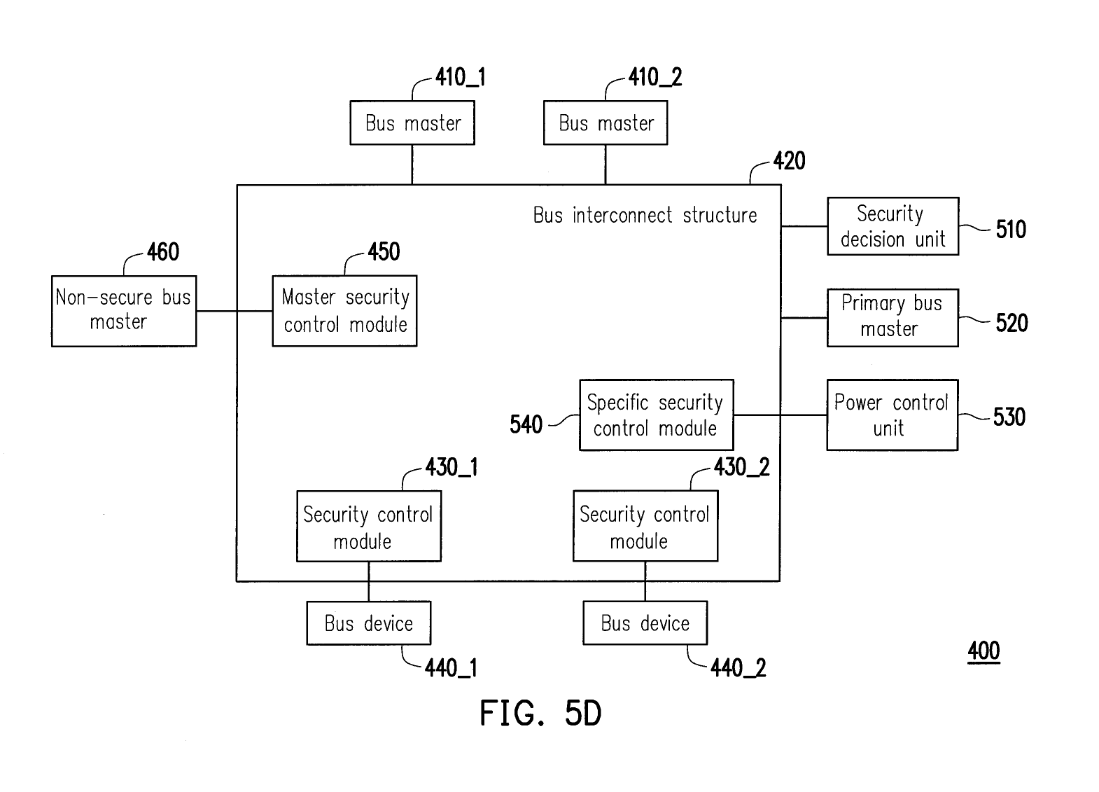

FIG. 5A is a schematic diagram illustrating a secure bus system according to FIG. 4C. In the present embodiment, the secure bus system 400 further includes a security decision unit 510, coupled to the bus interconnect structure 420. It should be noted that the security decision unit 510 could be regarded as the “security root” of the secure bus system 400. To be specific, none of the bus masters within the secure bus system 400 has the authority to modify or access security policies determined in the security decision unit 510.

The security decision unit 510 may help other devices of the secure bus system 400 to handle their security functions. In an embodiment, the security decision unit 510 may assign the default state to the security control modules 430_1 and 430_2 and the master security control module 450, by sending a default state setting information to them. In other embodiments, the security decision unit 510 may also send security control transactions to, for example, the security control module 430_1 and 430_2, but the invention is not limited thereto. As mentioned before, the security control transaction could be used to set the default security attributes of the security control module 430_1 and 430_2 when the security control module 430_1 and 430_2 are in the open state. In one embodiment, when the default security attributes of the security control module 430_1 and 430_2 are determined by the security control transactions from the security decision unit 510, the security decision unit 510 may allow the bus masters with enough security to modify the default security attributes of the security control module 430_1 and 430_2 again by sending the security control transactions, but the invention is not limited thereto. Further, in other embodiments, the security decision unit 510 could arbitrarily transit the security control module 430_1 and 430_2 to be any of the open state, known state or trap state.

Referring back to FIG. 3, the security control module 430_1 and the bus device 440_1 are taken as an example herein. The security control module 430_1 may determine whether a default state setting information is received from the security decision unit 510 after steps S330 and S340. If yes, the security control module 430_1 may modify its default state according to the default state setting information. If the security control module 430_1 does not receive the default state setting information from the security decision unit 510 after steps S330 and S340, the security control module 430_1 may maintain its default state, but the invention is not limited thereto.

In another embodiment, the security decision unit 510 may help the security control modules 430_1 and 430_2 and the master security control module 450 to handle the security violation condition. For example, when the security control module 430_1 triggers the security violation handling process, the security control module 430_1 may further send a notification to the security decision unit 510 about the security violation condition, in addition to transit to the trap state and determining the blocked area of the bus device 440_1. After receiving the notification, the security decision unit 510 may restrict the master security attribute of the bus master related to the security violation condition. For example, assuming that the bus master 410_1 causes the security violation condition, the security decision unit 510 may set the master security attribute of the bus master 410_1 to be the least secure level, such that the bus master 410_1 is less secure than the bus device 440_1. That is, the bus master 410_1 with the least secure level is not authorized to access any of the bus devices of the secure bus system 400. Or, the security decision unit 510 may disable the bus master 410_1 for preventing the bus master 410_1 from accessing other bus devices of the secure bus system 400.

Further, the security decision unit 510 may send a security resynchronization signal to the security control modules 430_1 and 430_2 to adjust the security permission flag related to the bus master 410_1. In other words, after the security decision unit 510 has found out that the bus master 410_1 may be malicious, the security decision unit 510 may notify security control modules 430_1 and 430_2 to correspondingly adjust the security permission flag related to the bus master 410_1, so as to protect the bus devices 440_1 and 440_2 from being accessed by the malicious bus master 410_1. In some embodiments, the security decision unit 510 may directly determine the default state for the security control modules 430_1, 430_2 and the master security control module 450 within the secure bus system 400. That is, although the security control modules 430_1, 430_2 and the master security control module 450 may respectively determine their own default state, the security decision unit 510 may further override the default states of the security control modules 430_1, 430_2 and the master security control module 450, but the invention is not limited thereto. In some embodiments, the security resynchronization signal could be implemented as the security control transaction, but the invention is not limited thereto.

From another point view, the present embodiment provides an aggressive method to protect the bus devices 440_1 and 440_2. In detail, except passively blocking the access from malicious bus master 410_1, the security control modules of bus devices may further notify the security decision unit 510. Afterwards, the security decision unit 510 may perform corresponding security functions to the malicious bus master 410_1 to protect the bus devices, such as disabling the malicious bus master 410_1.

FIG. 5B is a schematic diagram illustrating a secure bus system according to FIG. 4C. In the present embodiment, the secure bus system 400 further includes a primary bus master 520. The primary bus master 520 is configured to have the ability to handle security violation conditions for the bus masters 410_1, 410_2 and the non-secure bus master 460. For example, when the security control module 430_1 triggers the security violation handling process, the security control module 430_1 may further send a notification to the primary bus master 520 about the security violation condition in addition to transit to the trap state and determining the blocked area of the bus device 440_1. After receiving the notification, the primary bus master 520 may handle the security violation condition for the bus master that causes the security violation condition. For example, assuming that the bus master 410_1 causes the security violation condition, the primary bus master 520 may activate a security exception handler to access or receive internal information of the bus master 410_1 to analyze or fix the violation condition after receiving the notification from the security control module 430_1, but the invention is not limited thereto.

In other embodiments, when the security control module 430_1 triggers the security violation handling process, the security control module 430_1 may further send a notification to the bus master causing the security violation condition, in addition to transit to the trap state and determining the blocked area of the bus device 440_1. After receiving the notification, the bus master causing the security violation condition may activate a security exception handler for handling the security violation condition.

FIG. 5C is a schematic diagram illustrating a secure bus system according to FIG. 4C. In the present embodiment, the secure bus system 400 further includes a power control unit 530, which is coupled to the bus interconnect structure 420 through a specific security control module 540. Similar to the security control modules 430_1 and 440_1, the specific security control module 540 could be configured to perform the security functions for the power control unit 530, such as setting the security permission flags related to the bus masters 410_1, 410_2, and the non-secure bus master 460. The power control unit 530 may be configured for adjusting an operating condition of the bus devices 440_1, and 440_2 in response to an adjusting request of one of the bus masters 410_1, 410_2, or the non-secure bus master 460. The operating condition may be, for example, voltage, current or distribution of operating power, frequency, strength, or distribution of operating clock, or others the like, but the invention is not limited thereto. Assuming that the bus master 410_1 is trying to adjust the operating condition of the bus device 440_1, the bus master 410_1 may send the adjusting request to the power control unit 530. After receiving the adjusting request, the power control unit 530 may record the master security attribute of the bus master 410_1. In some embodiments, the power control unit 530 may further adjust the operating conditions of the bus masters 410_1, 410_2, the non-secure bus master 460 and the bus interconnect structure 420 according to the aforementioned teachings. Under this situation, the bus interconnect structure 420 may be regarded as a bus device and coupled to a corresponding security control module. As such, the power control unit 530 may control the operating conditions of the bus interconnect structure 420 through its corresponding security control module as previously discussed.

Next, the power control unit 530 may notify the security control module 430_1 of the bus device 440_1 with the master security attribute of the bus master 410_1 before adjusting the operating condition of the bus device 440_1. After being notified by the power control unit 530 with the master security attribute of the bus master 410_1, the security control module 430_1 may determine whether the device security attribute of the bus device 440_1 is defined to be more secure than the master security attribute of the bus master 410_1. If no, the security control module 430_1 may notify the power control unit 530 to normally adjust the operating condition of the bus device 440_1. However, if the device security attribute of the bus device 440_1 is defined to be less secure than the master security attribute of the bus master 410_1, the security control module 430_1 may determine the security violation condition has happened between the bus master 410_1 and the bus device 440_1. Afterwards, the security control module 430_1 may perform the security violation handling process to handle the security violation condition according to the aforementioned teachings, which would not be repeated herein.

Besides, the security control module 430_1 may further notify the specific security control module 540 that the security violation condition has happened between the bus master 410_1 and the bus device 440_1. Next, after being notified by the security control module 430_1, the specific security control module 540 may set the security permission flag related to the bus master 410_1 as a second flag state to consider further accessing to the power control unit 530 from the bus master 410_1 not secure. Hence, if the bus master 410_1 wants to adjust the operating conditions of other bus devices (e.g., the bus device 440_2) through the power control unit 530 again, the specific security control module 540 of the power control unit 530 would found out that the bus master 410_1 is not secure enough to perform such operation and would determine a security violation condition has happened for such operation request from the bus master 410_1.

FIG. 5D is a schematic diagram illustrating a secure bus system according to FIG. 5A-5C. In the present embodiment, the secure bus system 400 includes all the elements illustrated in FIG. 5A-5C. The elements illustrated in FIG. 5D may perform interactions to each other according to the previous teachings, which would not be repeated herein.

To sum up, the embodiments of the present invention provide a novel, effective and power-efficient way for the security control module to determine whether it is secure for the bus master to access the bus device related to the security control module. In short, after the security attributes of the bus master and the bus device are determined, the security control module may set the permission security flag to be the first flag state (i.e., the bus master is more secure than the bus device) or the second flag state (i.e., the bus master is less secure than the bus device) by comparing the master security attribute of the bus master and the device security attribute of the bus device only when either of the security attributes changed. Therefore, the security control module does not need to determine and compare security attributes of the bus master and the bus device upon every bus transaction, and hence the power consumption could be significantly reduced. Besides, when there occurs the security violation condition, the security control module may perform some aggressive security functions to further protect the bus device, such as transiting into the trap state, determining a blocked area in the bus device, responding the bus master with a normal response without correctly executing corresponding functions requested in the bus transaction, responding a dummy data when the bus transaction is a read request and/or sending a notification to the security decision unit, instead of simply passively blocking the access of the bus transaction related to the security violation condition.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A secure bus system, comprising:
a bus interconnect structure;
a bus master, coupled to the bus interconnect structure, having a master security attribute;
a bus device; and
a security control module, coupled between the bus device and the bus interconnect structure, determining a device security attribute for the bus device,
wherein when the master security attribute of the bus master has changed, or the device security attribute of the bus device has changed, the security control module determines a security permission flag related to the bus master, wherein the security permission flag is configured for indicating whether the bus master is secure enough to access the bus device;
wherein when the security control module receives a bus transaction from the bus master, the security control module determines whether a security violation condition happens between the bus master and the bus device according to the security permission flag related to the bus master; and
if the security violation condition happens, the security control module triggers a security violation handling process to further restrict accessibility of the bus master to the bus device.

2. The secure bus system as claimed in claim 1, wherein the security control module is configured for:
determining whether the security control module is in an initialization stage;
if yes, setting the device security attribute according to a default security attribute of the security control module;
if no, determining whether the bus device is bundled with another device;
if yes, setting the device security attribute according to a security attribute of the other device; and
if no, setting the device security attribute according to a reception condition of a security control transaction from the bus master.

3. The secure bus system as claimed in claim 2, wherein after the security control module determines the security control module is in the initialization stage, the security control module is configured for:
determining whether the default security attribute of the security control module is valid;
if yes, setting the device security attribute as the default security attribute and setting a default state of the security control module as a known state; and
if no, setting the default state of the security control module as an open state.

4. The secure bus system as claimed in claim 3, further comprising a security decision unit, coupled to the bus interconnect structure, and wherein after the default state of the security control module is set, the security control module is configured for:
determining whether a default state setting information is received from the security decision unit;
if yes, modifying the default state of the security control module according to the default state setting information from the security decision unit; and
if no, maintaining the default state of the security control module.

5. The secure bus system as claimed in claim 2, wherein after the security control module determines the bus device is bundled with another device, the security control module is configured for:
setting the device security attribute according to a security attribute of the other device when the other device has the security attribute.

6. The secure bus system as claimed in claim 2, wherein after the security control module determines the bus device is not bundled with another device, the security control module is configured for:
setting the device security attribute of the bus device as the master security attribute of the bus master when receiving the security control transaction from the bus master.

7. The secure bus system as claimed in claim 1, wherein the security control module determines the security permission flag related to the bus master by comparing the device security attribute of the bus device and the master security attribute of the bus master,
wherein when the device security attribute is defined to be less secure than the master security attribute, the security control module sets the security permission flag related to the bus master to be a first flag state, wherein the first flag state of the security permission flag represents that the bus master is secure enough to access the bus device,
wherein when the device security attribute is defined to be more secure than the master security attribute, the security control module sets the security permission flag related to the bus master to be a second flag state, wherein the second flag state of the security permission flag represents that the bus master is not secure enough to access the bus device.

8. The secure bus system as claimed in claim 7, wherein when the security control module receives the bus transaction from the bus master, the security control module is configured for:
determining whether the security control module is in a trap state, wherein the trap state represents that the bus master cannot normally access the bus device;
if no, determining whether the security permission flag related to the bus master is the first flag state; and
if no, defining that the security violation condition has happened.

9. The secure bus system as claimed in claim 8, wherein when the security control module triggers the security violation handling process, the security control module is configured for:
transiting into the trap state; and
determining a blocked area in the bus device.

10. The secure bus system as claimed in claim 8, wherein when the security control module triggers the security violation handling process, the security control module is configured for:
responding the bus master with a normal response without correctly executing corresponding functions requested in the bus transaction.

11. The secure bus system as claimed in claim 8, wherein when the security control module triggers the security violation handling process, the security control module is configured for:
responding a dummy data when the bus transaction is a read request.

12. The secure bus system as claimed in claim 8, further comprising a security decision unit, coupled to the bus interconnect structure, wherein when the security control module triggers the security violation handling process, the security control module is configured for sending a notification to the security decision unit about the security violation condition,
wherein after receiving the notification, the security decision unit restrict the master security attribute of the bus master related to the security violation condition,
wherein the security decision unit sends a security resynchronization signal to the security control module to adjust the security permission flag related to the bus master.

13. The secure bus system as claimed in claim 8, further comprising a security decision unit, coupled to the bus interconnect structure, wherein when the security control module triggers the security violation handling process, the security control module is configured for sending a notification to the security decision unit about the security violation condition,
wherein after receiving the notification, the security decision unit disables the bus master that causes the security violation condition.

14. The secure bus system as claimed in claim 8, further comprising a primary bus master, coupled to the bus interconnect structure, wherein when the security control module triggers the security violation handling process, the security control module is configured for sending a notification to the primary bus master about the security violation condition,
wherein after receiving the notification, the primary bus master handles the security violation condition for the bus master that causes the security violation condition.

15. The secure bus system as claimed in claim 8, wherein when the security control module triggers the security violation handling process, the security control module is configured for sending a notification to the bus master causing the security violation condition,
wherein after receiving the notification, the bus master causing the security violation condition may activate a security exception handler for handling the security violation condition.

16. The secure bus system as claimed in claim 1, further comprising a power control unit, coupled to the bus interconnect structure through a specific security control module, wherein the power control unit is configured for adjusting an operating condition of the bus device in response to a adjusting request of the bus master,
wherein after receiving the adjusting request, the power control unit records the master security attribute of the bus master,
wherein the power control unit notifies the security control module of the bus device with the master security attribute of the bus master before adjusting the operating condition of the bus device.

17. The secure bus system as claimed in claim 16, wherein after being notified by the power control unit with the master security attribute of the bus master, the security control module is configured for:
determining whether the device security attribute of the bus device is defined to be more secure than the master security attribute of the bus master;
if no, notifying the power control unit to normally adjust the operating condition of the bus device; and
if yes, determining the security violation condition has happened between the bus master and the bus device.

18. The secure bus system as claimed in claim 17, wherein the security control module further notifies the specific security control module that the security violation condition has happened between the bus master and the bus device,
after being notified by the security control module, the specific security control module sets the security permission flag related to the bus master as a second flag state to consider further accessing to the power control unit from the bus master not secure.

19. A bus system security method, adapted to a secure bus system comprising a bus interconnect structure, a bus master, a bus device and a security control module, wherein the method comprises:
determining a device security attribute for the bus device,
when a master security attribute of the bus master has changed, or the device security attribute of the bus device has changed, determining a security permission flag related to the bus master, wherein the security permission flag is configured for indicating whether the bus master is secure enough to access the bus device;
when receiving a bus transaction from the bus master, determining whether a security violation condition happens between the bus master and the bus device according to the security permission flag related to the bus master; and
if the security violation condition happens, triggering a security violation handling process to further restrict accessibility of the bus master to the bus device.
